(19) United States
(12) Patent Application Publication
(10) Pub. No.: US 2020/0162410 A1
(43) Pub. Date: May 21, 2020

(54) MANAGEMENT OF MESSAGING IN HETEROGENEOUS IOT / IIOT MESSAGING ENVIRONMENTS

(71) Applicant: Gavan Welleseley Hood, Helensvale (AU)

(72) Inventor: Gavan Wellesley Hood, Helensvale (AU)

(21) Appl. No.: 16/195,910

(22) Filed: Nov. 20, 2018

(51) Int. Cl. H04L 12/58; G06F 9/54; G06F 9/445; H04L 12/24; H04L 29/08

(52) U.S. Cl. CPC H04L 51/066; H04L 51/36; H04L 67/12; G06F 9/44526; H04L 41/0816; G06F 9/546

(57) ABSTRACT

The subject innovation relates to communications systems, more particularly heterogeneous messaging systems and methods to facilitate configuration, execution and management of messaging across multiple messaging systems (MS) within a heterogeneous communications environment as is found in Internet of things (IOT) and industrial internet of things (IIOT) environments. It similarly relates to message exchanges within computing devices. It relates to a novel technique for representing key messaging parameters for configuration, messaging and execution in a messaging technology independent form which when processed and deployed enables end to end message exchange and management from senders to receivers across the disparate messaging systems and within different memory environments present.

### CROSS-REFERENCE TO RELATED APPLICATIONS

This application continues the previous Provisional application

Title: MANAGEMENT OF MESSAGING IN HETEROGENEOUS IOT/HOT MESSAGING ENVIRONMENTS

EFS ID 31111312

Application No. 62/593,975

Confirmation Number 6372

The present application claims priority to the earlier filed provisional application having Ser. No. 62/593,975, and hereby incorporates subject matter of the provisional application in its entirety.

### BACKGROUND OF THE INVENTION

Internet of things (IOT) generally refers to wide variety of intelligently connected devices that can be widely distributed supporting varied communication technologies and messaging systems (MS). Whilst devices in these environments are widely distributed they also communicate with systems within the devices via internal communications capabilities found in IIOT/IOT machine control, robotics and software systems.

In an IOT/IIOT environments message systems connect devices, applications and machines that are able to connect to that messaging system. Within the device there may also be communication between process instances and between executable code within a process instance. IOT/IIOT environments have a number of variations over traditional messaging environments. Examples of these variations are presented below:
Devices vary greatly in processing power from embedded systems to enterprise systems.
Communications protocols vary from complex self-describing message formats to opaque byte arrays.
Configurations are dynamically changing in terms of topology of devices, applications and MS implementations.
Messaging infrastructure varies from Intra machine processing to extra machine processing.
Extra process communications protocols vary from lightweight wireless systems with compact binary representations to self-describing text based protocols.
Multiple message exchange scenarios exist. Message exchange semantics vary from simple point to point connections to many to many publish subscribe and service orientated systems in the one environment.
Applications vary from embedded applications written in low-level languages to enterprise applications using high level languages and scripts.
Communications infrastructure varies from in memory and low-level serial interfaces to distributed wireless low bandwidth systems and internet/local area network (LAN) systems.

Current messaging systems support a subset of these various options. In a given IOT/IIOT environment a broad set of these variations are likely in a given embodiment with multiple MS implementations operating independently configured and managed separately as a subset of the plurality of messaging systems implemented. As such the management and exchange of messages in these heterogeneous environments is often disconnected with limited cross system interaction.

The lack of uniformity across MS technologies and MS implementations is due in part to targeted requirements for the individual MS technology and/or implementation and the acquisition of implementations from different vendors. A particular subset of messaging capability is the focus of a given MS technology, there is no focus on the exchange of messages across the various technology and alternatives.

Some opaque message MS technologies (OMMS) (e.g.: MQTT, RS485) support message exchange with limited structure which have broad application with limited or no definition of data structure, data or semantic validation; others employ complex object model definition processes (OBJMS) (e.g.: ISA 95) which provide object structure without capabilities for implementation data and semantic validation.

OBJMS systems do not integrate well to other OBJMS technologies without substantial ad hoc coding which is typically implemented on a specific implementation as a minimal one-off integration capability.

Some OBJMS technologies allow themselves to be overlaid over an individual OMMS technology using the OMMS as the transport mechanism (e.g.: OPC UA), this does not represent interoperability between other OMMS implementations and the OBJMS/OMMS implementation.

Some OBJMS technologies allow configuration via application programming interfaces (APIs) (APIS's) and configuration files (e.g.: DDS-RTPS). These artefacts are internally focused on allowing a user to configure that system and are not focused on aligning multiple MS on a common configuration as presented in this document. The ability to span multiple MS technologies requires the implementation independent representation of the key messaging capabilities which can then be transformed into individual messaging system representations. There has not been a mechanism to configure message definitions and exchange logic that can span all MS systems.

There has not been a method defined to allow messages to modify its form between OMMS and OBJMS environments. Being able to convey the message which may be a complex representation and meta data across a low-level point to point message transports that supports only Byte format messages and be able to then transfer over complex

Similarly, there has not been an extensible method of data format validation and semantic validation of message content that can be applied across the message flows across senders and receivers in OMMS and OBJMS environments.

There has not been a mechanism to specify end to end configuration of system management parameters (for example embodiments are diagnostic, health, security, encoding, quality of service (QOS)) and monitoring of these parameters from a common configuration source independent of any specific MS technology/implementation.

There has not been a mechanism to specify end to end message definitions spanning the heterogeneous OMMS/OBJMS environments.

There has not been a mechanism to provide system diagnostics that span end to end information exchanges across the heterogeneous OMMS/OBJMS environments.

### SUMMARY OF THE DISCLOSURE

The innovation relates to methods and mechanisms that support messaging across IOT environments that can span multiple OMMS and OBJMS technologies and applications interacting with these MS implementations.

Allowing the definition of message structure, data format and semantic description, message distribution rules in an implementation/technology independent form which generates multiple application and MS adaptor modules simultaneously which facilitate transfer of messages across the environment(s) from senders to receivers.

The innovation defines a framework which enables the generation process to be extended at key stages allowing the range of output configurations to be extended to meet new environment variations in this dynamic environment without requiring changes to the core generating process.

The system involves processing methods including the dynamic formation of meta data that encapsulates the message payload to provide message exchange information necessary for transfer over the disparate MS and application environments.

The innovation defines a mechanism for messages to be scale down to binary encodings required for specific environments and up to object representations if required.

The innovation allows the exchange of message headers and bodies in a variety of embodiments during the exchange from sender to receiver.

The invention describes the structure of modules which contain logic and configuration that allows the interaction of applications with multiple messaging systems using binary and complex structures as defined in the configuration along with meta data indicating the semantic, distribution and data information about the message required for distribution and consumption of the message.

The invention describes a definition component that comprises the information (semantic, data context, data structure and distribution rules) required to generate and configure modules, generate MS interfaces if required and to process messages and objects in modules once created.

The invention describes the dynamic reconfiguration of modules to allow processing of information not described at the time of the initial modules creation.

The invention describes the ability for modules to interact with multiple MS technologies simultaneously from within a single module processing instance or by combination of a plurality of modules into the one processing instance. A process instance may be within the one or more computing machines and may interact various communications embodiments such as but not restricted to network communications, local machine communications or shared memory environments.

The invention describes the ability to associate key information for system health, diagnostic, security, encoding, topics, QOS and other message processing parameters with the message allowing the correct navigation of messages over a plurality of MS implementations and management of the running MS system.

The innovations module and configuration processing embodiments provide the ability for modules to support component embodiments present and future with plug in ability of components that can be attached at key points within the modules logic and configuration processing to enable new capabilities to be added as they are become available.

The innovation describes an extensible message/application processing pipeline that can call into applications to allow fine grained validation of semantics, data formats and message construction as well as other aspects of the message packing and unpacking process.

The invention will now be described more fully hereinafter with reference to the accompanying drawings, which are intended to be read in conjunction with both this summary, the detailed description and any preferred and/or particular embodiments and variations specifically discussed or otherwise disclosed. This invention may, however, be embodied in many different forms and should not be construed as limited to the embodiments set forth herein; rather, these embodiments are provided by way of illustration only and so that this disclosure will be thorough, complete and fully conveys the full scope of the invention to those skilled in the art.

### BRIEF DESCRIPTION OF THE DRAWINGS

FIG. 1 “Example diagram of a heterogeneous message system according to one illustrative embodiment” is an Illustrative diagram of a possible embodiment where Modules facilitate application access in different languages to various MS implementations and applications. The configuration processor generates updates to the modules in the system based on the system configuration which is documented in the profile. The elements presented may be present in a number of embodiments such as software, firmware and hardware embodiments.

The modules and act as adaptors between disparate MS implementations. The common configuration of modules enables applications and devices to receive consistent information context regardless of the connection point to the messaging system implementations in place.

The configuration of modules is expressed in an implementation/technology independent format examples of which are presented in [400] and are described in profile documents that present the configuration in publications that explain details of the configuration.

FIG. 2 “Example diagram of a heterogeneous message system according to one illustrative embodiment” is a diagram presenting an illustrative example of one possible set of steps when messages are sent from a sender where the messages are assembled and passed to a messaging system. After passing through successive Messaging Systems (of which some example technologies are provided) guided by the meta data associated with the message the message arrives at receiver where it is converted into the form acceptable to to the receiver application. The modules are able to monitor the flow of messages across the messaging systems and report statistics/diagnostics/performance information back to monitoring systems in out of band communications if configured. The structure of a message may vary from compact binary representations to fully self-described messages depending on the capability of the messaging systems at each stage.

FIG. 3 “Module generation method illustrative embodiment” illustrates a possible set Module definition processing steps (MODPROC). Loaded definitions of messages undergo lexical and syntactical analysis to form a global token representation of intermediate code which acts as an abstract message configuration model which acts as an abstract message and module definition independent of any messaging system technology or implementation.

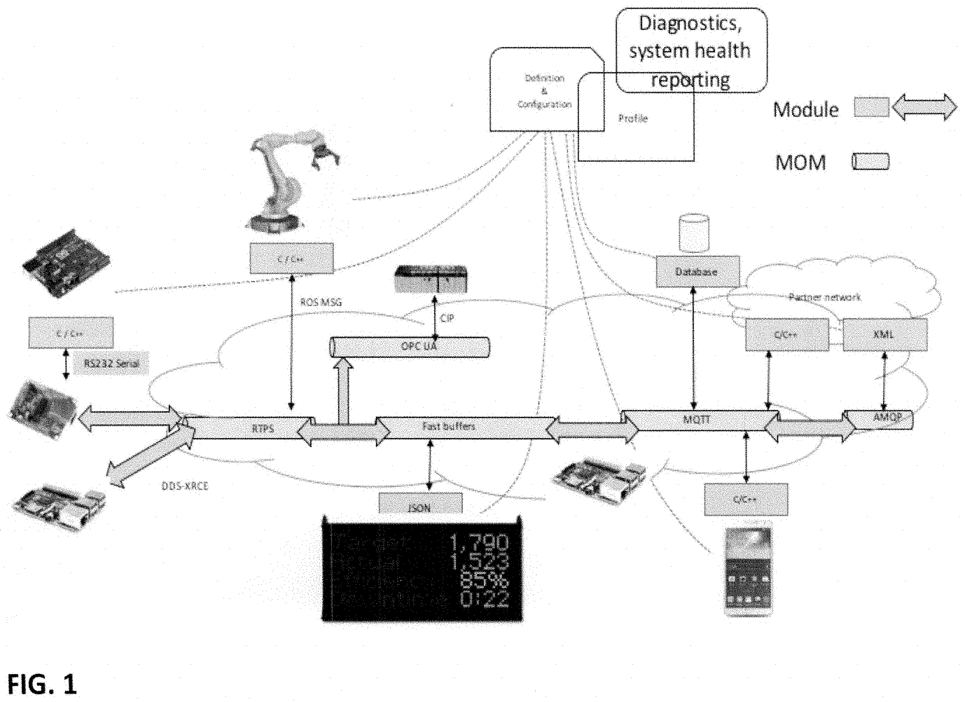

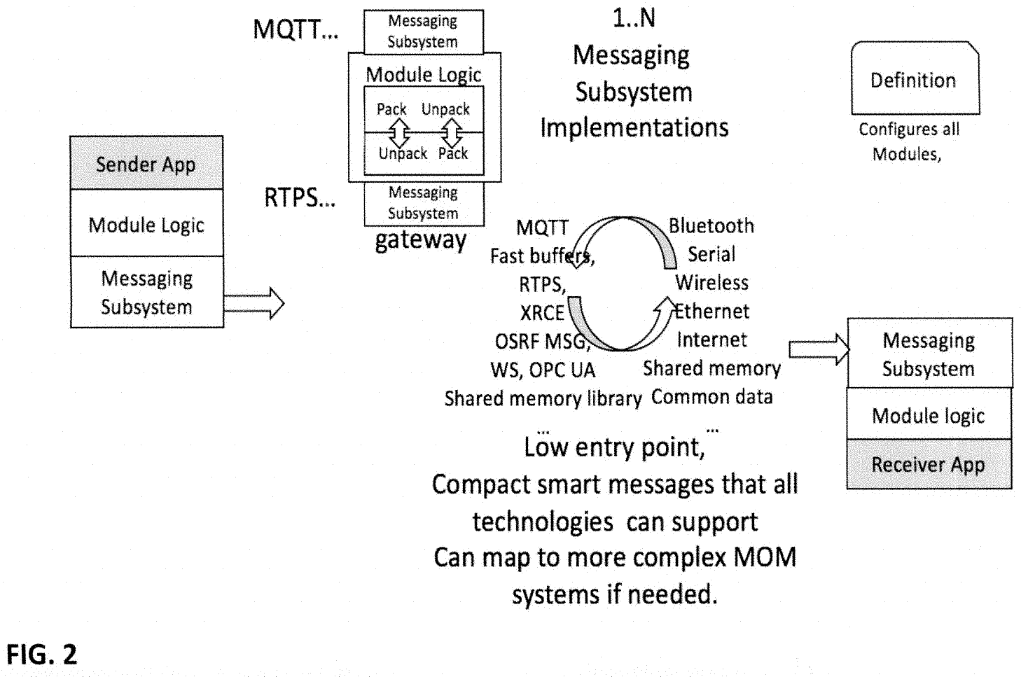

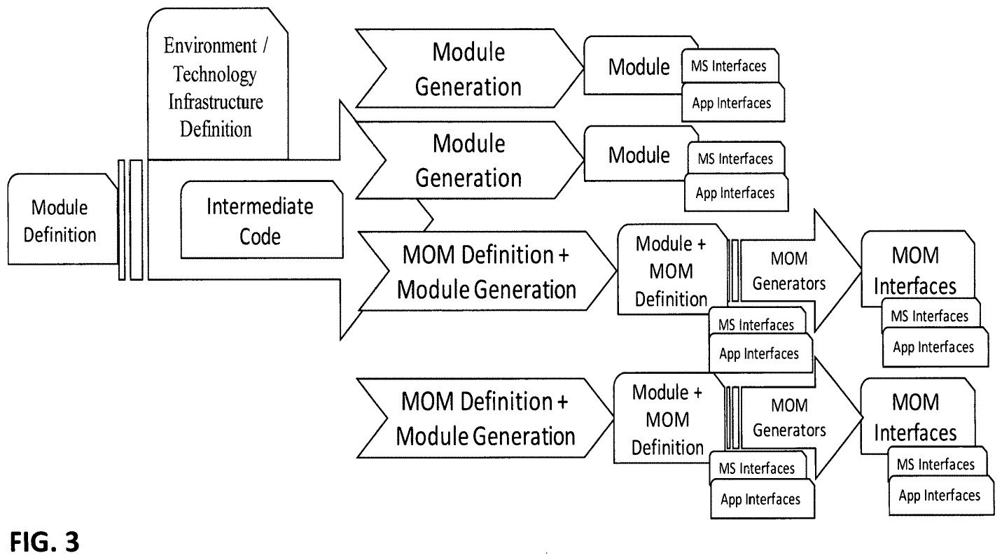

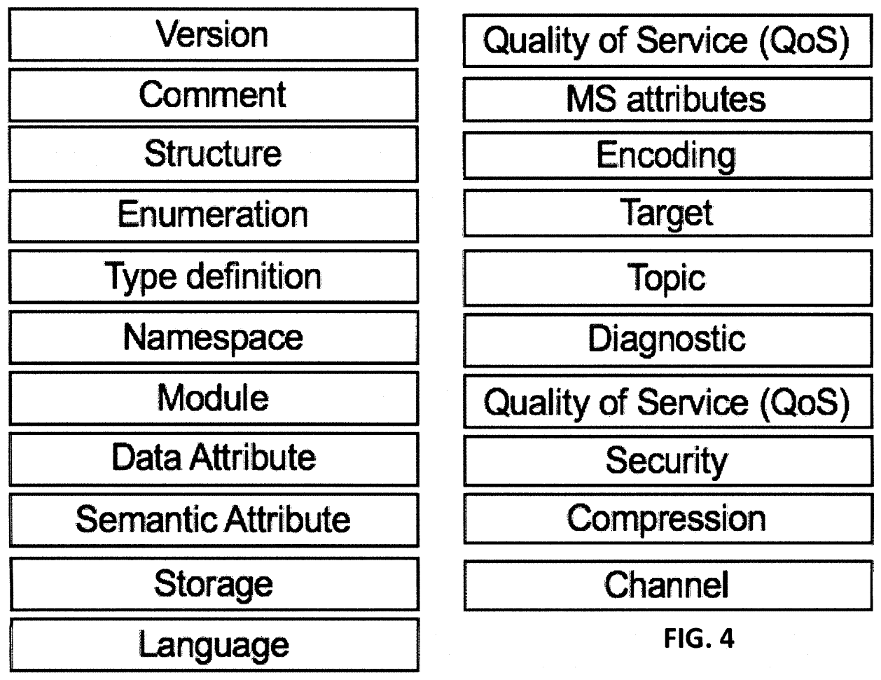

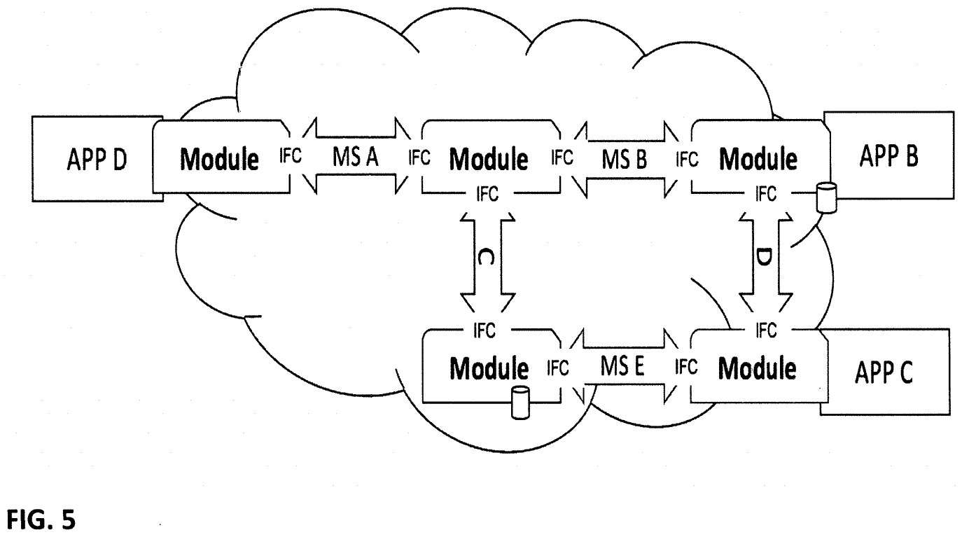

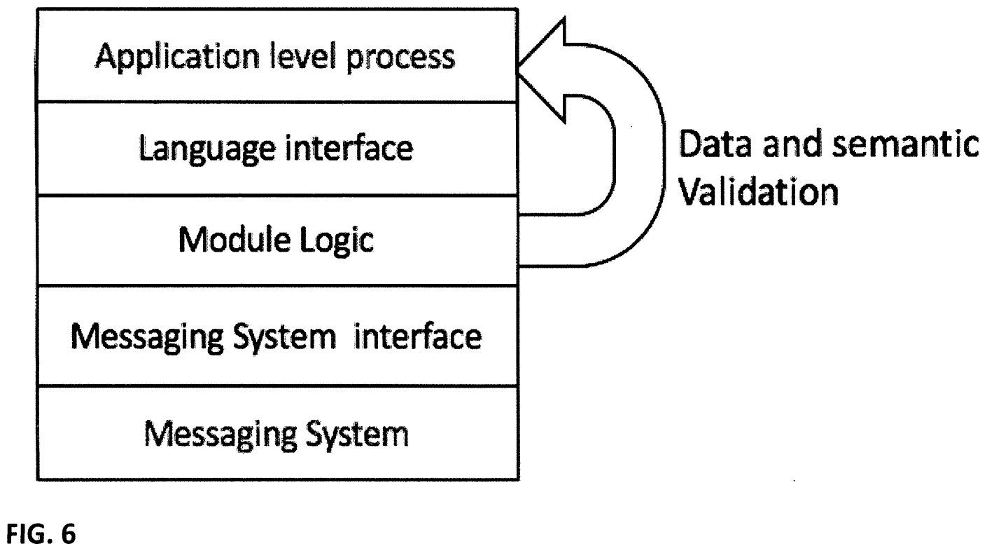

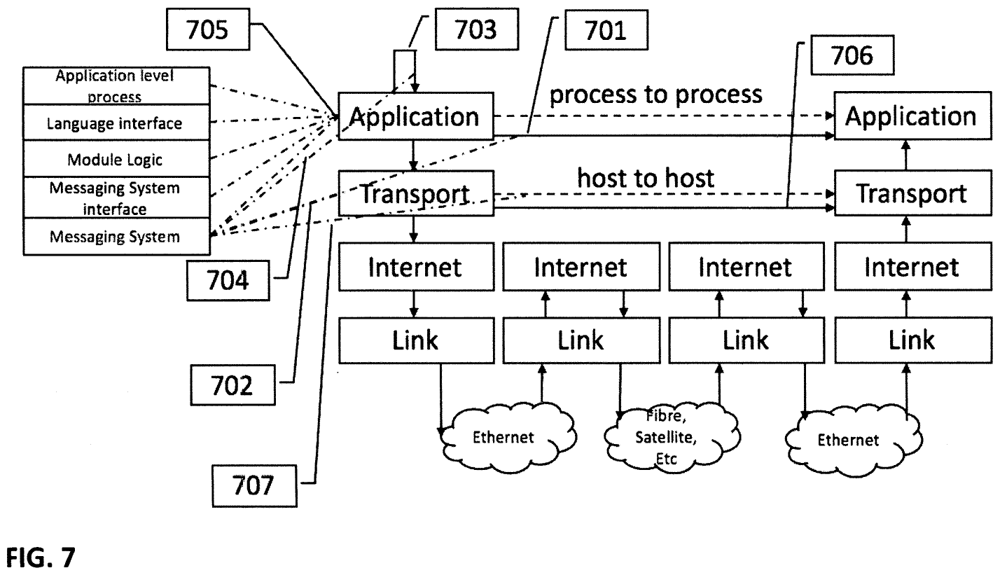

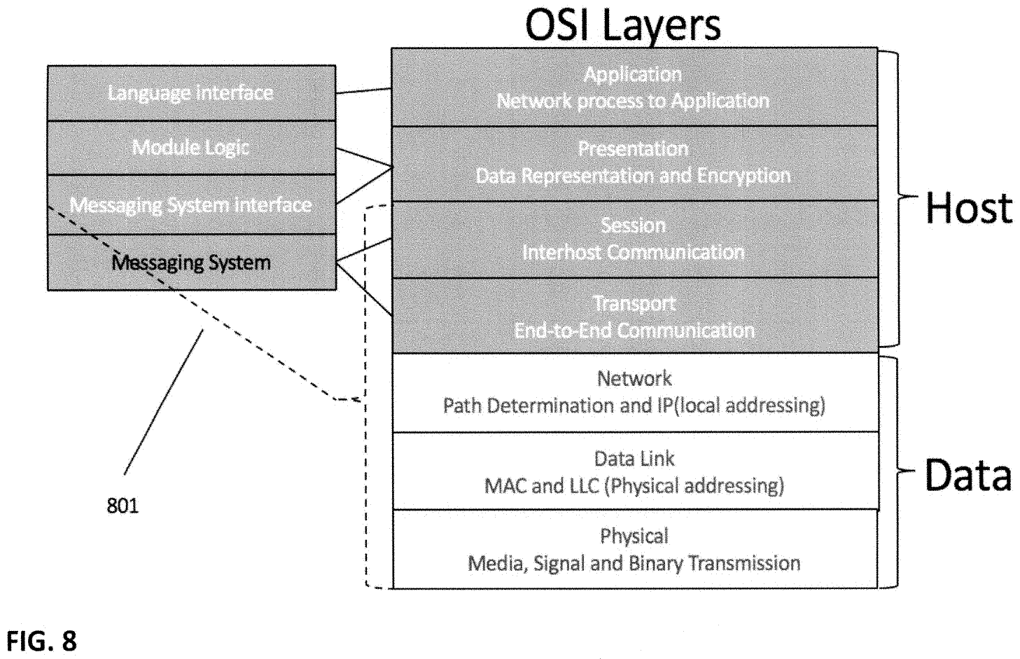

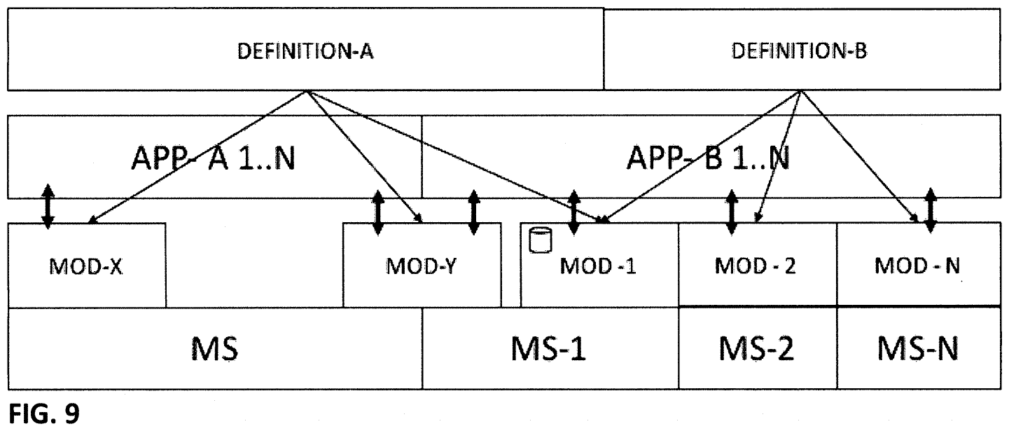

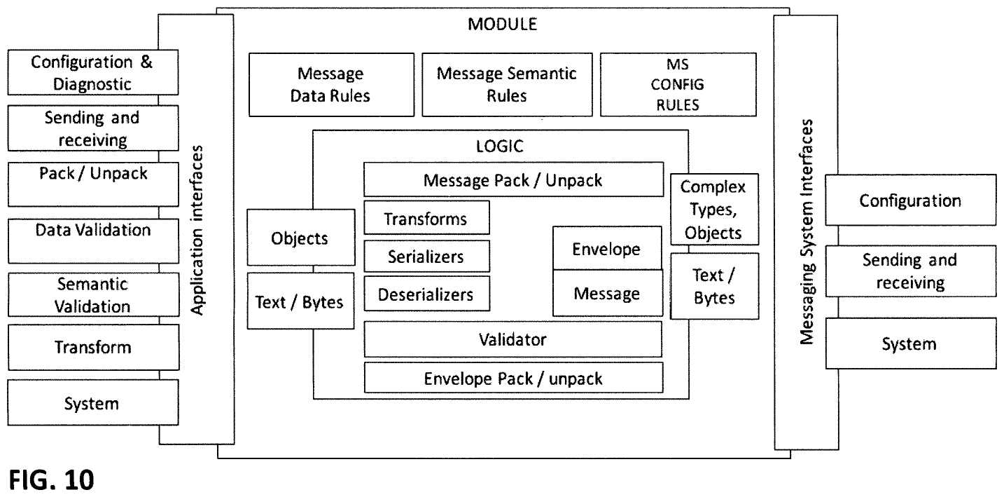

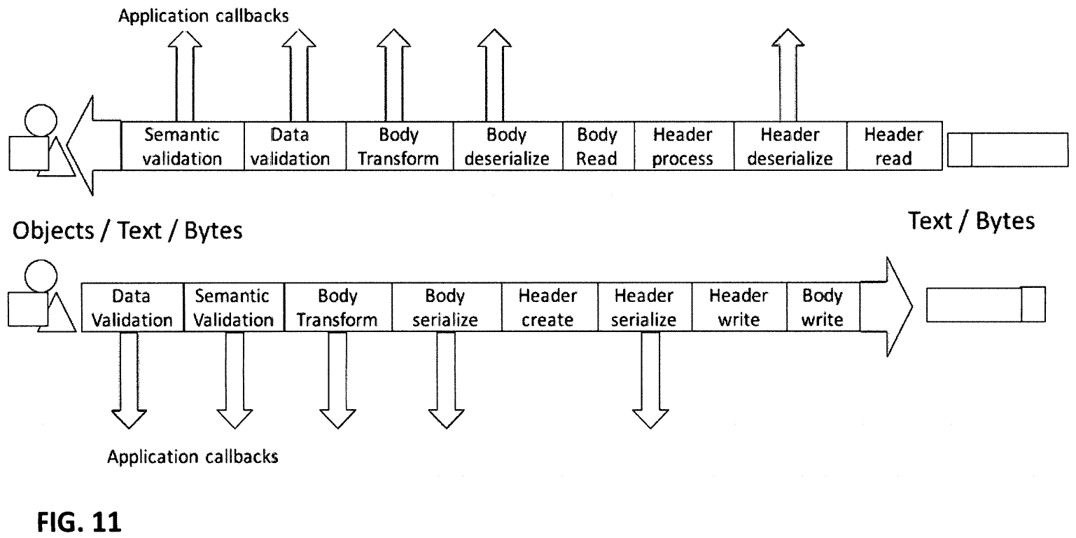

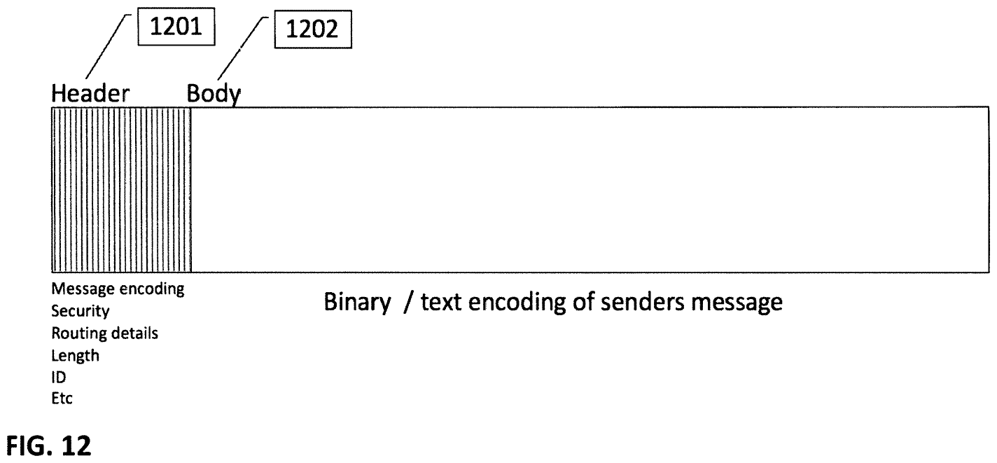

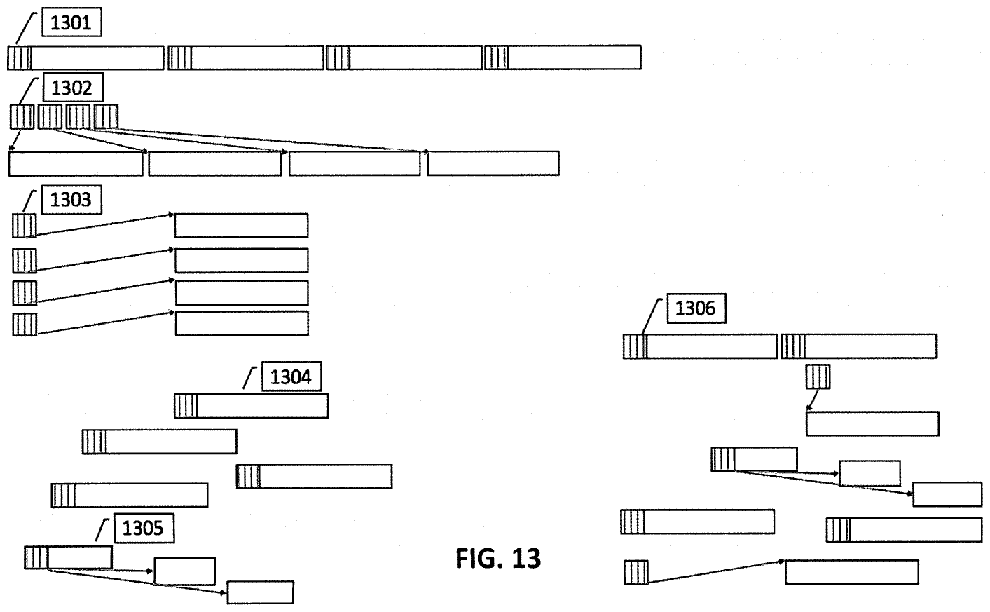

The generator parses this model in the context of a specified environment, technology and infrastructure which contains the required targets and module generators.

Module generators and Module/MOM generators are called for each token in the sequence of tokens in the intermediate code creating the necessary module components as shown in FIG. 10 “A block diagram illustrating module components according to one illustrative embodiment”. This may occur as each token is processed or at stages during the token processing or before/after processing of tokens is performed. The Modules contain interfaces to application and messaging systems which allow a number of message processing embodiments some of which are presented below:
Configuration of messages received and transmitted
Processing of message instances (sending, receiving, packing, unpacking, transforming, data validation, semantic validation
System function for configuration diagnostics and system health reporting of module functions

The modules/module logic required for processing the information as shown in FIG. 10 “A block diagram illustrating module components according to one illustrative embodiment” are created or updated as required. These updates may be created in a number of embodiments some of which are listed below:
Incremental logic updates to be deployed to running modules
Creation of new modules
Data that leads to creation or update of modules

For the plurality of MOM systems where a specific MOM system requires an interface generation step from a MOM definition to develop the MOM MS interface. A MOM generation step may be performed to generate the required MS interfaces to that MOM.

FIG. 4 “Module definition example attribute embodiment” illustrates an example of possible module configuration definition attributes that are processed in the module update environment in various embodiments one of which is the configuration of the modules within the heterogeneous messaging system.

FIG. 5 “Module interaction environment illustrative embodiment” Illustrates a possible embodiment of modules within a plurality of Messaging Systems (MS A, B, C, D, E) and Applications (APP B, C, D). acting as adapters between technologies. Modules may store information as defined in their configuration.

In FIG. 6 “Module message processing illustrative embodiment” modules receive messages from inbound MS interfaces and send the information via outbound MS interface based on knowledge contained in the Message envelope and module configuration. Modules can call back to Application level context as part of the message processing if configured to identify message processing actions. An example embodiment of a message processing call back is presented in FIG. 11 “Module message/object processing steps according to one illustrative embodiment”. Interactions with modules for configuration updates and message processing are recorded in system interfaces with diagnostics and module health updates that may be reported in a plurality of connected applications some of which are:
System audit processes
System health dashboards

Modules are typically deployed in environments with multiple MOM/MS implementations and applications. Messages traverse various MOM/MS implementations in various embodiments. An example is one that is defined in the configuration in data declarations. The embodiment of the message body is defined by configuration instructions that describe the content of the message and message processing functions. Examples are:
objects/complex structures in their serialized format requiring only the capability to exchange the minimalist structure being a byte array.
Memory images of the object
Compressed forms of the object
Textual forms of the object
   The message processing rules typically advise how to process the message based on rules in various embodiments, examples of these embodiments are:
message mappings,
conversions,
aggregation
encryption/decryption
translation

FIG. 6 “Module to system interactions example according to one embodiment” represents system interactions according to on possible embodiment. In this example three functions of a module considered are the interaction with application for objects to be exchanged and MS systems for messages to be exchanged. Upon receipt of objects, Text or Bytes from applications the modules process items for transmission and on receipt of messages process messages for presentation to applications. The modules base on configured rules may call into Applications for data and semantic level validation. Some semantic and data validation rules may also be represented in the module itself. An example embodiment of the processing of messaging and objects is presented in FIG. 11 “Module message/object processing steps according to one illustrative embodiment”.

FIG. 7 “Example Module relationship to Internet model” provides a diagram illustrating a representation of the internet model and an example of module embodiment relationships to the Internet model.

The internet model presents a data flow that passes from the Application to application via transports that exchange data over the internet and the links contained within the internet (each link being to a network connection of some form).

705 illustrates that application, module and messaging systems activities can be considered application level activities in the

701/702 illustrates a data flow represented in the innovation not represented in the internet model being direct process to process data flow represented in point to point (For example: Shared memory etc.) possible in IOT/IIOT environments.

703/704 represents another data flow not represented in the internet model being intra process and collocated process data flows possible in IOT/IIOT environments.

705 illustrates that application to module to messaging system functions are considered application level activities in the Internet model.

FIG. 8 “Example Module relationships to OSI layer model” provides a diagram illustrating example Module in relationships to OSI layered model. Whilst modules will often be related to the host layers of the OSI model where lower layers are handled by the messaging systems and infrastructure they are deployed upon. There are instances where the lower OSI layers are also represented in modules. Examples of this could be intra process exchanges, serial communications and other messaging systems where external Messaging Systems are not required, do not exist or unable to add value to the Module.

FIG. 9 “Module, Definition and Messaging computer system according to one embodiment” presents a possible messaging computer system according to one possible embodiment. Multiple definitions and modules interacting over multiple MS implementations. In this example embodiment consideration of the alignment of Modules and definitions allows messages to be partitioned within groups of modules in the system.

In FIG. 9 “Module, Definition and Messaging computer system according to one embodiment” the example embodiment shows how modules are able to support multiple MS implementations in a given module instance but can also be attached to other modules to provide interfaces that span MS implementations that are not present in a specific module. Whilst Modules can be dynamically updated to provide additional MS support in this embodiment it is desired to support multiple MS implementations by combining Modules. In this embodiment, the Module MOD contains information that enables APP-A1 . . . N and APP-B1 . . . N to exchange messages defined in Definition A. Messages defined in Definitions-B would be restricted to Application ins APP-B1 . . . : N. Module 1 (Mod1) has been configured to store messages as part of its configuration.

FIG. 10 “A block diagram illustrating module components according to one illustrative embodiment” Illustrates a block diagram of one possible embodiment of a module. In this example embodiment, the module functions are as presented below which are optional processing activities depending on the configuration and rules specified in the module:
Serialize/deserialise objects/messages in supported languages to configured encoding and target software language.
Transform from local to network form which may involve structure, data and semantics changes.
Validation of objects and message with call backs into application level functions for extended data and semantic validation if required
Wrap/unwrap application message body with intelligent envelope as described in 1100 and 1200.
Interaction with messaging systems/messaging infrastructure to send/receive messages and configuration.
Interacts with other modules for system level functions such as but not restricted to:
   System health
   Diagnostics
   Security
   Logging
   Routing
   Lookups for message references
   Encodings
   QoS negotiation
   Topic resolution
   MS mappings

Modules may be realized in many forms of embodiment such as presented below but not limited to:
MS to MS gateway in single or multiple modules connected
MS to App end point
Realized as application endpoint or messaging technology gateway
Application to messaging infrastructure code
Messaging Infrastructure technology to technology adaptors
Intra process connectors
Cross process connectors
Cross machine connectors

Where MS interfaces (BYTE/Text level exchanges) are available the module is directly constructed. Examples are:
MQTT
Serial (RS232, RS385 . . . )
TCP/IP
Zigbee
AMQP
UDP/IP

Where complex type exchange on specific MS technologies which support this are present the Byte/Text level interfaces are still supported as a base level communications format.

Optionally these may elect to use complex type structures available in MS technology as presented in the following examples:
Memory copies of the object in system memory
Text formats of the object (e.g. JSON, XML)
ROS MSG,
OMG DDS,
OPC UA,
Fast Buffers

In each embodiment, the physical structure of the module will be aligned with the environment which would be significantly different. An embodiment containing the description of the module will provide identification of the supported capabilities. Examples of possible embodiments are configuration interface information and profile documents.

FIG. 11 “Module message/object processing steps according to one illustrative embodiment” represents one illustrative embodiment of a possible sequence of steps in module message-object.

In the example Module embodiments object to message steps are represented as a standard framework for processing application object to and from messages in its MS module interfaces.

The objects and processing rules are provided by configuration. Module processing is initiated by arrival of messages on one of the MS interfaces or on an application interface.

During this process messages and objects are processed from either end of a message processing pipeline when messages are unpacked into envelope and body which are then deserialized into objects where data and semantic validation occurs. Callbacks to application level functions allows application/instance level validation to occur. The populated item form is then presented to the application interfaces. The reverse sequence occurs when applications submit items to the module. Steps in the sequence are optional and can be eliminated, modified or extended depending on the module configuration the message.

FIG. 12 “Example Message structure embodiment according to one illustrative embodiment” represents an example message structure embodiment

In the example message embodiment, the base message structure is a smart message encoding containing a message header 1201 and body 1202.

The message header 1201 contains context information that can be used to provide information to modules and MS systems and application call-backs that facilitate transfer across different MS implementations. Example embodiments of content are topics, universal resource identifiers, QoS specifications, and message encoding/security keywords.

The example message header 1201 and body 1202 encoding may be identified in a message header embodiment which may vary during the message exchange lifetime across different MS's. Examples of the encoding embodiments are:
byte array of data (serialized data, memory copy of data, compressed form of data)
structured text (JSON, XML . . . )
another structure/package being exchanged on another connection/channel/memory location

FIG. 13 “Example message header to message body exchange embodiments” represents different embodiments of the message instances exchanged

The message headers may be transferred in many different embodiments, the association of the two may vary as the messages traverse the technologies from sender to receiver. Example embodiments are:
1301 Discretely and sequentially where the header and body are sent together as a discrete unit in and are presented sequentially from message to message between sender and receiver. The order of transmitted messages is retained from sender to receiver. Notification of the arrival of a header infers the arrival of the body.
1302 Indexed and sequentially where the header and body are sent separately as individual units. Headers are presented sequentially from message to message between sender and receiver. Bodies are presented separately in a sequential manner are located by indexes in the header. Notification of the arrival of a header may not infer the arrival of the body.
1303 Indexed and random where the header and body are sent separately as individual units in no specific order. Bodies are located by indexes in the header. Notification of the arrival of a header may not infer the arrival of the body.
1304 Discretely and random where the header and body are sent together as a discrete unit in and presented in a random manner from sender to receiver. The order of message transmission is not retained from message sender to receiver. Notification of the arrival of a header infers the arrival of the body.
1305 Indexed and random where the header and body are sent separately. The header and body may be fragmented into multiple units sent separately. Notification of the arrival of heady and body elements may not infer arrival of the complete header or body.
1306 Multiple message embodiments illustrating that a given embodiment may include any or all of possible embodiments concurrently including those described in this document.

### BRIEF DESCRIPTION OF THE INVENTION

The present invention is directed to MESSAGING CONFIGURATION AND MANAGEMENT HETEROGENEOUS IOT/IIOT MESSAGING ENVIRONMENTS

In its most complete version, the system is made up of the following components:
A plurality of configurations of modules and messages
A plurality of configurations of target IOT/IIOT environments
A plurality of mappings between configurations
Configuration processor
A plurality of modules interfaced to messaging systems
A plurality of modules containing messaging system capability
A plugin capability within modules and configuration processor to enable addition of new components as they become available.
A plurality of application interfaces
A plurality of the above in software, firmware and hardware

These components are combined together in part or in total to create an architecture for the system that has the ability to define the configuration, management and execution of messages in a heterogeneous messaging system environment.

The system may have two embodiments a configuration embodiment and an execution embodiment which may operate concurrently. These embodiments may be further classified in embodiments termed with names such as diagnostics, execution, runtime, maintenance, design, documentation.

In the configuration embodiment definitions of system wide configurations are managed along with target system environment configurations. These configurations may be processed in a configuration processor which generates modules and updates to modules as required to deliver a cohesive messaging system that spans the plurality of messaging systems in the target environment. In some target instances, a messaging system may not be available directly in the target environment but is able to be generated by the configuration processor and supported by the module.

It is important to note that the management, execution and analysis capabilities are defined in an implementation independent form that spans the individual often disparate messaging systems enabling end to end messaging and management of messaging.

In the execution embodiment modules which have been generated and configured in the configuration embodiment support the creation, exchange and management of message occurrences across installed messaging systems and in some instances across messaging systems generated by the configuration embodiment.

As discussed, the invention has many different features, variations and multiple different embodiments. The invention has been described in this application at times in terms of specific embodiments for illustrative purposes and without the intent to limit or suggest that the invention conceived is only one particular embodiment. It is to be understood that the invention is not limited to any single specific embodiments or enumerated variations.

Many modifications, variations and other embodiments of the invention will come to mind of those skilled in the art to which this invention pertains, and which are intended to be and are covered by both this disclosure. It is indeed intended that the scope of the invention should be determined by proper interpretation and construction of the disclosure, including equivalents, as understood by those of skill in the art relying upon the complete disclosure at the time of filing.

The innovation presented represents messaging configuration and execution across multiple MS implementations in a given IOT/IIOT environment in a framework that can be extended as required to meet the needs that arise in the future. This ability addresses a number of serious challenges in IOT/IIOT systems such as inefficiency, errors and security, system health and management issues across the wide range of variation in this environment

I claim:

1. A platform of methods and mechanisms that support messaging across IOT/IIOT environments that can span multiple OMMS and OBJMS technologies and applications interacting with these MS implementations. Comprising:
A representation of the messaging system in an implementation independent data format
A configuration component that automatically configures at least a portion of the messaging system based at least in part upon metadata that describes the messaging system in an implementation independent format.
A monitoring component that monitors and manages processing of messages that are exchanged using various message embodiments from senders to receivers in the heterogeneous messaging environment in a common data and visualization format.
Modules configured and generated in part or in full by the configuration component that facilitate message exchanges within the messaging environment.

2. The methods and mechanisms of claim 1 further comprising methods for definition of message structure, data format, and semantic description and message distribution rules in an implementation/technology independent form which when processed generates multiple application and MS adaptor modules simultaneously which facilitate transfer of messages across the environment(s) from senders to receivers and management of the overall MS environment.

3. The methods and mechanisms of claim 1 further comprising methods for a framework which enables the generation process to be extended at key stages allowing the range of output configurations to be extended to meet new environment variations in this dynamic environment without requiring changes to the core generating process.

4. Processing methods including the dynamic formation of meta data from message configuration and processing rules. The meta data encapsulates the message payload to provide message exchange information necessary for transfer over the disparate MS and application environments.

5. The methods of claim 4 further comprising methods for a mechanism for messages to be automatically scaled down to binary encodings required for specific environments and up to text and/or complex structures and/or hierarchical object embodiments as required.

6. The methods of claim 4 further comprising methods for a mechanism that allows the exchange of message headers and bodies in a variety of embodiments during the message exchange from sender to receiver.

7. Modules which are defined and configured by definition components containing logic, rules and configuration that allows the interaction of applications with multiple messaging systems using binary and complex structures as defined in the configuration along with meta data indicating the semantic, distribution and data information about the message required for distribution and consumption of the message. Comprising:
Rules configuration components for message data, message semantic processing and messaging system capabilities
Logic components for processing inputs from applications and messaging systems to other messaging systems and applications
Interfaces to applications for at least parts of stages of message and object processing and system configuration
Interfaces to messaging systems for configuration sending and receiving and system configuration.

8. The methods of claim 7 further comprising methods for a definition and configuration component that compiles input information (semantic, data context, data structure, mappings and distribution rules) to generate and/or configure modules, generate MS interfaces if required and to process messages and objects in modules once created.

9. The methods of claim 7 further comprising configuration processes allowing dynamic reconfigurable modules to allow processing of information not described at the time of the initial modules creation.

10. The methods of claim 7 further comprising methods for modules to interact with multiple MS technologies simultaneously/concurrently from within a single module processing instance or by combination of a plurality of modules interacting in the one processing instance. A process instance may be within the one or more computing machines and may interact various communications embodiments such as but not restricted to network communications, local machine communications or shared memory environments.

11. The methods of claim 1 further comprising methods for the ability to associate key information for system health, diagnostic, security, mapping, encoding, topics, QOS and other message processing parameters with the message allowing the correct navigation of messages over a plurality of MS implementations and management of the running plurality MS systems in part or full.

12. The methods of claim 7 further comprising methods for modules and configuration processors to support components present and future with plug in ability of components that can be attached at key points within the modules logic and configuration processing to enable new capabilities to be added as they are become available.

13. The methods of claim 7 further comprising methods for an extensible message/application processing pipeline that can back call into application layer logic to allow fine grained validation of semantics, data formats and message construction as well as other aspects of the message packing and unpacking process.

14. The methods of claim 4 further comprising methods that provide the ability of a message header and body to alter their instantiation and relationship during its lifetime from sender to receiver.

15. The methods of claim 1 comprising the mechanism of a plurality of message processing modules to integrate a plurality of application and messaging systems of different ontologies (including data, semantic and implementation distinction) into a connected messaging environment that can be created, configured, managed and operated as common message exchange environment.

16. The methods of claim 1 comprising a mechanism to configure, monitor and report on the allowed variation from no change thru to unlimited changes in message body and message header encoding/structure/semantics at each module as the message traverses the messaging infrastructure.
